(19) United States
(12) Patent Application Publication
(10) Pub. No.: US 2010/0328447 A1
(43) Pub. Date: Dec. 30, 2010

(54) CONFIGURATION OF DISPLAY AND AUDIO PARAMETERS FOR COMPUTER GRAPHICS RENDERING SYSTEM HAVING MULTIPLE DISPLAYS

(75) Inventor: Brian Watson, Burlingame, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Sony Computer Entertainment, Inc., Tokyo (JP)

(21) Appl. No.: 12/493,027

(22) Filed: Jun. 26, 2009

(51) Int. Cl. G09G 5/377; G09G 5/12; H04N 7/18

(52) U.S. Cl. 348/135; 345/1.3; 345/629; 348/E07.085

(57) ABSTRACT

To coordinate a coherent view across multiple display devices having an arbitrary physical layout, display offsets are determined by a computing platform based on image information received from a camera coupled to the computing platform. The computing platform may apply edge detection algorithms to determine relative positions, orientations and sizes of each of the multiple display devices from which display offsets associated with each display device may be derived as configuration settings for use in a subsequent rendering of a views to be displayed across the display devices.

### RELATED APPLICATIONS

This application is related to co-pending U.S. patent application Ser. No. 12/492,883, entitled, “Networked Computer Graphics Rendering System with Multiple Displays”, filed on Jun. 26, 2009 and U.S. patent application Ser. No. 12/493,008, entitled, “Networked Computer Graphics Rendering System with Multiple Displays for Displaying Multiple Viewing Frustums”, filed on Jun. 26, 2009, the disclosure of which is incorporated herein by reference in its entirety for all purposes.

### FIELD OF THE INVENTION

The present invention relates generally to computer graphics rendering systems including multiple displays, and more particularly to configuration of display parameters for the multiple displays.

### DESCRIPTION OF THE RELATED ART

Computer graphics applications continue to improve the realism of rendered scenes to increase the entertainment or simulation value of computer game or CAD applications. An effect known as “immersion” can contribute to the realism of rendered scenes. Immersion refers to moving the perspective of the graphics application user from that of an outsider looking into scene to a perspective of being part of the scene. Immersion may be achieved by increasing the FOV of a rendered scene through the use of multiple display devices. However, the view to be displayed across multiple display devices of a graphics rendering system is typically predetermined and independent of an actual physical positioning or “layout” of the display devices. Such limitations prevent a user from customizing the view rendered across the plurality of display devices via an intuitive physical placement of the displays and may also result in an incoherency of the view across display devices arbitrarily positioned.

### BRIEF DESCRIPTION OF THE DRAWINGS

Embodiments of the invention are particularly pointed out and distinctly claimed in the concluding portion of the specification. Embodiments of the invention, however, both as to organization and method of operation, together with objects, features, and advantages thereof, may best be understood by reference to the following detailed description when read with the accompanying drawings in which:

FIG. 1 illustrates a schematic diagram of multiple display device graphics rendering system coupled to a camera, in accordance with an embodiment of the present invention;

FIG. 2 illustrates a schematic diagram of a multiple display system denoting exemplary display layout parameters which may be determined by processing of image information collected by a camera, in accordance with one embodiment of the present invention;

FIG. 3 is a flow diagram illustrating a display configuration method, in accordance with an embodiment of the present invention;

FIG. 4 is a flow diagram illustrating a screen position configuration method, in accordance with an embodiment of the present invention;

FIG. 5 is a flow diagram illustrating a screen orientation configuration method, in accordance with an embodiment of the present invention;

FIG. 6 is a flow diagram illustrating a screen size configuration method, in accordance with an embodiment of the present invention;

FIG. 7 is a flow diagram illustrating a screen spacing configuration method, in accordance with an embodiment of the present invention;

FIG. 8 illustrates hardware and user interfaces that may be used to configure a layout of multiple display screens, in accordance with one embodiment of the present invention; and

FIG. 9 illustrates additional hardware that may be used to process instructions, in accordance with one embodiment of the present invention.

For clarity of illustration, elements illustrated in the figures have not necessarily been drawn to scale. For example, the dimensions of some of the elements may be exaggerated relative to other elements. Further, where considered appropriate, reference numerals have been repeated among the figures to indicate corresponding or analogous elements.

### DETAILED DESCRIPTION

Described herein is a system and method for coordinating a coherent view across multiple displays of a graphics rendering system based on optical imaging of the display device layout. In the following detailed description, numerous specific details are set forth in order to provide a thorough understanding of embodiments of the invention. However, it will be understood by those skilled in the art that other embodiments may be practiced without these specific details. In other instances, well-known methods, procedures, components and circuits have not been described in detail so as not to obscure the present invention. Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Some portions of the detailed description which follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of actions or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like

Unless specifically stated or otherwise as apparent from the following discussion, it is appreciated that throughout the description, discussions utilizing terms such as “processing”, “computing”, “converting”, “reconciling”, “determining” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. In one embodiment, the apparatus for performing the operations herein includes a game console (e.g., a Sony Playstation®, a Nintendo Wii®, a Microsoft Xbox®, etc.). A computer program may be stored in a computer readable storage medium, such as, but not limited to, any type of disk including floppy disks, optical disks (e.g., compact disc read only memory (CD-ROMs), digital video discs (DVDs), Blu-Ray Discs™, etc.), and magnetic-optical disks, read-only memories (ROMs), random access memories (RAMs), EPROMs, EEPROMs, magnetic or optical cards, or any type of media suitable for storing electronic instructions.

The terms “coupled” and “connected,” along with their derivatives, may be used herein to describe structural relationships between components of the apparatus for performing the operations herein. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g., as in a cause an effect relationship).

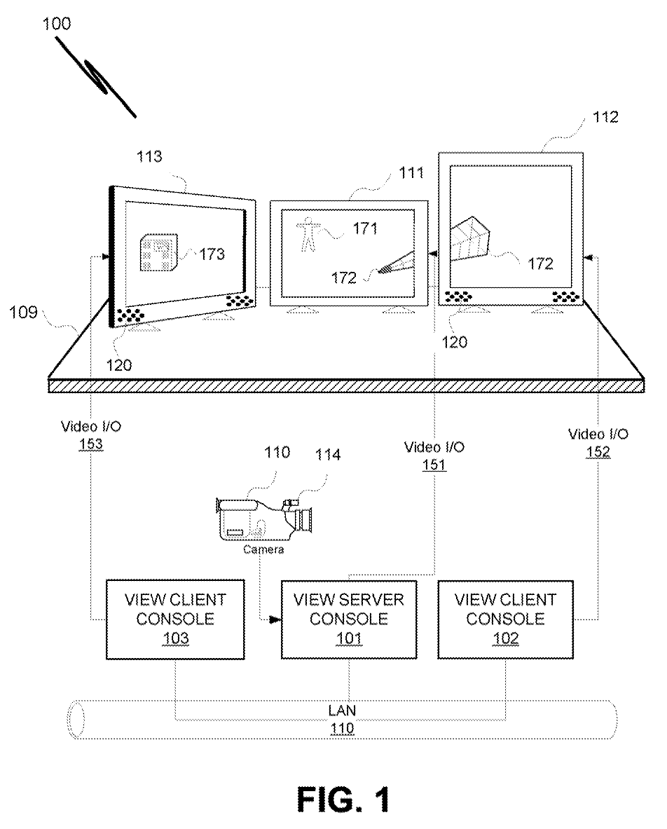

In an embodiment, a multiple display graphics rendering system includes a plurality of computing platforms with each computing platform to generate and render graphics for display on a display device of the system. FIG. 1 illustrates a perspective view of a multiple display graphics rendering system 100, in accordance with one embodiment of the present invention where each computing platform is a game console. In alternative embodiments however, the depicted game consoles may each be replaced by any conventional computer having a programmable processor. As depicted, the system 100 includes three game consoles, a view server console 101 and view client consoles 102 and 103, although any number of consoles may be included in a system.

As illustrated in FIG. 1, the system 100 includes client display devices 111-113, each of which are disposed on a table 109. The display devices have an arbitrary display layout as defined by a linear position and an orientation (i.e. angular position) relative to a reference coordinate system of a view server display device 111. In an embodiment, each computing platform in a multiple display graphics rendering system is connected to a single display device. For such embodiments, a one-to-one ratio of computing platforms to display devices is maintained regardless of the number of computing platforms included in a system. Each display device in the system is to display graphics generated and rendered by the computing platform to which it is coupled. In an alternative embodiment however, a computing platform may be connected to more than one display device, whereby the computing platform would generate and render graphics for the two or more connected display devices. For example, a multiple display graphics rendering system may have only a single computing platform driving each of the plurality of display devices 111-113.

In the particular embodiment depicted in FIG. 1, the view server console 101 is coupled to the view server display device 111 by a video data I/O link 151. The view server display device 111 is to display graphical output, such as graphics objects 171 and 172, generated by the view server console 101. The view server display device 111 includes a display screen which may be of any display technology known in the art, such as, but not limited to, an LCD, a plasma display, a projection display, a cathode ray tube (CRT). Similarly, the video data I/O link 151 may utilize any technology known in the art for transmitting video, such as, but not limited to, component video, S-video, composite video a High Definition Multimedia Interface (HDMI). The view client consoles 102 and 103 are each similarly coupled through a video data I/O link 152 or 153 to a view client display device, 112 or 113, respectively. The view client display device 112 displays graphical output, such as graphics object 172, generated by the view client console 102 while the view client display device 113 displays graphical output, such as graphics object 173, generated by the view client console 103.

In a further embodiment, a multiple display graphics rendering system includes a plurality of audio speakers which may be arbitrarily positioned relative to each other. For example, view client display devices 112 and 113 each include embedded audio speakers 120 with relative positions dictated by the relative positions of the view client display devices 112 and 113. A plurality of standalone audio speakers may also be included in a multiple display graphics rendering system with one or more of the plurality coupled to a computing platform of the system (e.g., consoles 101-103).

In embodiments employing multiple computing platforms, such as the exemplary embodiment depicted in FIG. 1, each of the computing platforms in a multiple display graphics rendering system is coupled together over a network of communication links. The network may be any network known in the art, such as, but not limited to, one of the Ethernet family of frame-based local area network (LAN) computer networking technologies. In one embodiment, the only computing platforms which are physical nodes on the LAN 105 are those actively generated and rendering one of the multiple displays of the system 100. In an exemplary single computing platform embodiment, view server console 101 is coupled to each of the display devices 111-113 and generates all of the graphics objects 171-173.

As depicted in FIG. 1, rendered graphics objects are to be displayed across the display devices 111-113 as a coherent view of a same world space. In a particular embodiment, the view rendered and displayed is dependent on the physical layout of the display devices 111-113, as positioned by a user. For example, the portion of graphics object 172 displayed by view client display device 112 is coherent with the portion of the graphics object 172 displayed by the view server display device 111 even though the physical layout of the display devices 111 and 112 may not be rigidly fixed to predetermined positions, orientations, or screen sizes. As a further example, a graphics rendering application executed on a system where a user positions view client display device 112 to be adjacent to view server display device 111, as depicted in FIG. 1, may render a different view on view client display device 112 (e.g., “front window view”) than is rendered when a user positions view client display device 112 to be 90° to the right of the user's position (e.g., a “side window” view). As such, a user may intuitively modify a view of a graphical world rendered by the system merely be physically repositioning the display screens and executing a display configuration application on a computing platform.

In one embodiment, to render a coherent view which is dependent on the physical layout of the display devices, a configuration routine is first executed with at least one of computing platforms of the multiple display graphics rendering system coupled to a camera, such as camera 110, to collect image information pertaining to the physical layout of the display devices. From the collected image information, display offsets may be determined as configuration setting to subsequently be applied as predetermine offsets to views rendered for display on a particular display device. In this manner, a rendered view of an application's world space is made dependent on the physical layout of the display devices. In a further embodiment, to provide a surround sound environment with the multi-display system, a configuration routine is first executed to determine a position of the center of the system relative to the position of the audio speakers.

The camera 110 may be any still image or motion video recording device, such as, but not limited to, a conventional CCD camera. The camera 110 may further include a microphone 114 for use in configuring the audio of the system. In a particular embodiment, where the computing platform is a Sony Playstation® game console, the camera is an EyeToy® video camera, as further described elsewhere herein. The camera 110 is to include a lens with a sufficiently wide FOV to collect image information on at least two separate display devices. Generally, the wider the camera FOV, the more important it is to remove, with image processing, aberrations such as the “fish-eye” effect that can hinder the ability to accurately determine display offsets based on the information received from the camera. In an exemplary embodiment, a camera is equipped with a lens having a 45-60° FOV.

The image information to be collected by camera 110 include graphics actively displayed as a view on at least one of the multiple display devices during the display configuration and/or images of the display devices 111-113 in a passive mode not displaying graphics. For example, camera 110 may collect an image of bezel edges on the display devices 111-113. During execution of a configuration application, the camera 110 is to be positioned at a vantage point of a user of the system with two or more of the display devices 111-113 within the field of view (FOV) of the camera 110. In a particular embodiment, only one computing platform (e.g., view server console 101) in a multiple display graphics rendering system is coupled to the camera 110 and that computing platform executes a configuration application to determine display parameters for one or more of the display devices based on the image information received from the camera 110.

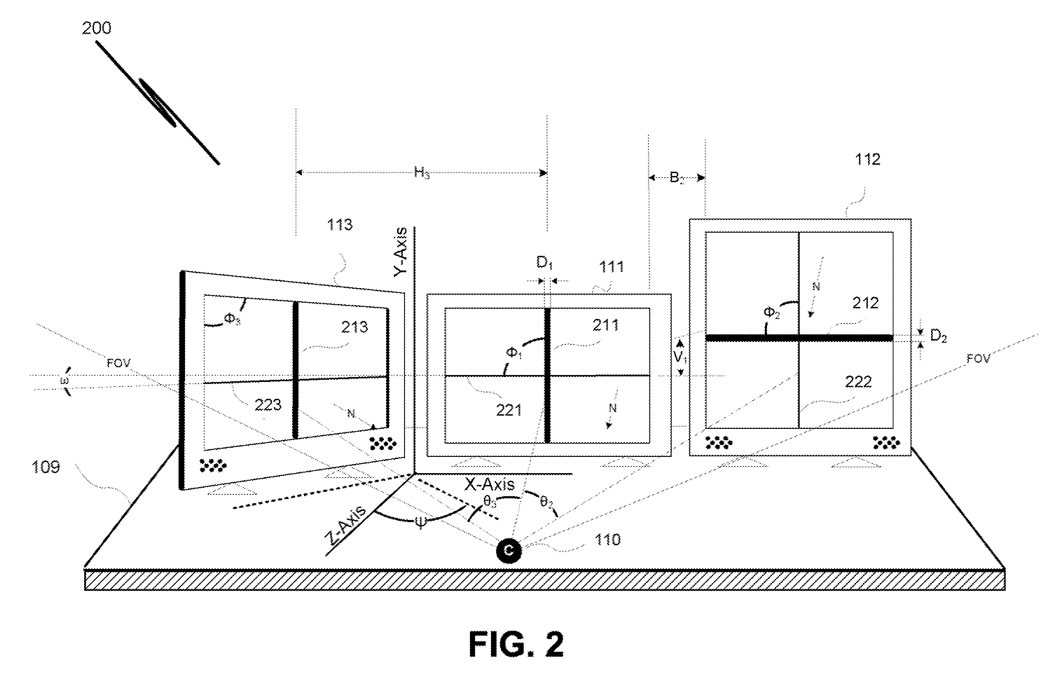

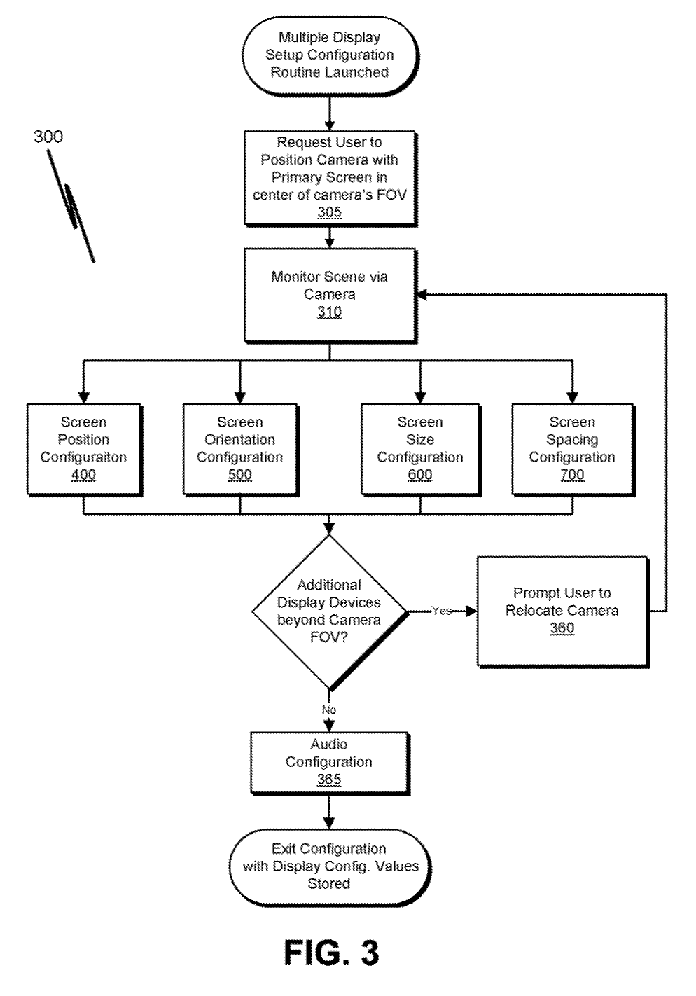

FIG. 2 illustrates a schematic diagram of a multiple display system 200 denoting exemplary display layout parameters which may be determined from image information collected by a camera 110 positioned to include the display devices 111-113 within the camera's FOV. The exemplary display parameters and the like may be used as offsets or scaling factors during the rendering of a coordinated view space from a generated world space of a graphics rendering application. FIG. 3 illustrates flow diagram for a multiple display configuration method 300 which may be employed to determine the exemplary display and speaker layout parameters denoted for system 200.

Method 300 begins with launching a multiple display configuration application on a computing platform coupled to a camera (e.g., camera 110) and a plurality of display devices to be configured (e.g., display devices 111-113). Launching of the configuration application may be in response to a user request or automatically triggered by an event, such as upon system boot up. For example, for environments where frequent displacement of display devices may be expected, a graphics rendering application which is to use the plurality of display devices may default to execute a display configuration application each time a particular graphics rendering application title is launched.

At operation 305, the computing platform detects a presence of the camera and issues a request for a user to position the camera at the vantage point of a system user during system use. For example, the camera 110 may be placed at a seated user's eye level. The computing platform may further request a user to position the camera with the display device that is to be the center of a system user's predominant focus during system use at approximately the center of the camera's FOV. In other words, the camera is to face the display device where a user is most likely to be gazing during system use. For example, as depicted in FIG. 2, the camera 110 is positioned to have the view server display device 111 approximately at the center of the camera FOV. During operation 305, the computing platform may display in real time the image information received from the camera onto a display device coupled to the platform executing the configuration routine so that a user may have visual feedback to properly center the camera FOV.

At operation 310 the computing platform begins monitoring the scene via the camera and thereby receiving any display screen output from the display devices within the camera field of view. The computing platform executing the display configuration application proceeds to process the received image data to perform one or more of a screen position configuration 400, a screen orientation configuration 500, a screen size configuration 600 or a screen spacing configuration 700, as described in further detail elsewhere herein.

If the computing platform determines based on performance of one or more of these operations that additional display devices beyond the camera FOV are present on the system, at operation 360, the user is prompted to relocate the camera to place additional display devices within the camera FOV such that a least one of the display devices that was previously in the camera FOV remains within the camera FOV, albeit proximate to a FOV edge. The configuration method 300 then returns to operation 310 to collect and process image data pertaining to the additional display devices.

When all display devices have been monitored by the computing platform via the camera, the configuration method 300 continues to operation 365 where audio speaker locations may be mapped with a microphone, such as one included in the camera utilized for display mapping. Audio speaker locations may be mapped to an associated display device to coordinate auditory placement of sounds associated with a rendered graphics object with the visual placement of that object within the multi-display system. The configuration routine may further perform automatic mapping of the individual audio channels (e.g., 5.1 surround sound, 3-2 stereo, etc.) of particular audio speakers associated with a display device and the computing platform driving the display device.

For example, referring back to FIG. 1, audio speakers 120 which are separately driven by the view client consoles 102 and 103 may be controlled by the view server console 101 during the operation 365 to map the audio channel(s) of view client console 102 and audio channel(s) of view client console 103. Based on the audio channel mapping performed by view server console 101 using the audio pickup provided by the microphone 114, audio configuration parameters may then be generated by the configuration routine executing on view server console 101. Such audio configuration parameters may then be employed by the view client consoles 102 and 103 to provide properly processed audio signals (e.g., trimmed, boosted and/or filtered from a default configuration) that have been shaped in a manner dependent upon the relative positions of the audio speakers 120 as dictated by the relative positions of the view client display devices 112 and 113. The method 300 then completes with the display configuration and/or audio configuration settings stored in a manner accessible to graphics rendering applications subsequently executed on the respective computing platforms of the multiple display graphics rendering system.

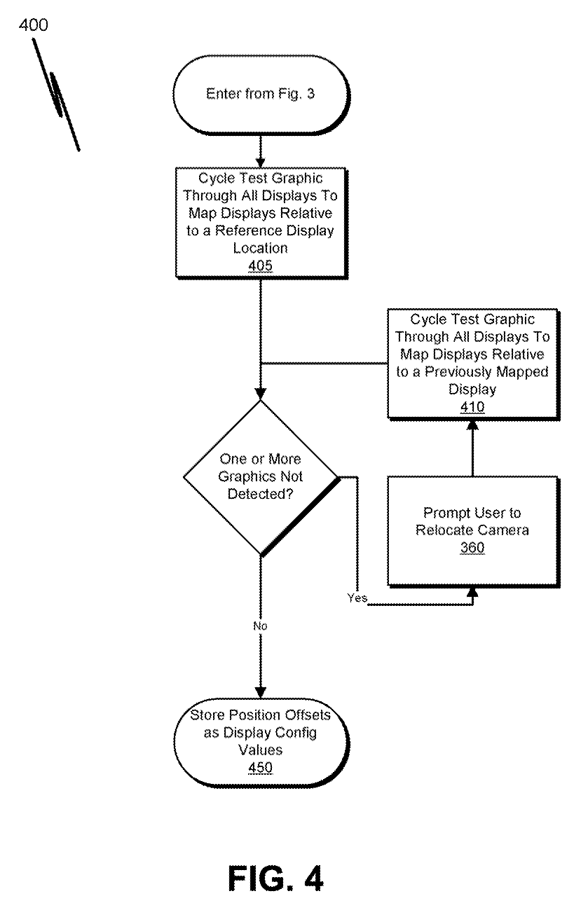

FIG. 4 illustrates an exemplary screen position configuration method 400. Method 400 begins cycling a color or high contrast test pattern through all display devices of the system at operation 405. The displayed color or test pattern may be static, flashed at a predetermined frequency or moved across a display screen at a predetermined rate. During this process, the color or test pattern is displayed on each of the display devices coupled to the system. For example, for embodiments where display devices are coupled to separate computing platforms which are networked (e.g., system 100), the computer platform executing the configuration routine requests successive displays, using local network traffic, to display a color or high contrast test pattern, or a series of such patterns where motion video may be collected during execution of the configuration routine. In an embodiment, the computer platform executing the configuration application uses image information received from the camera during the display cycling operation 405 to first identify and map the display device occupying the center of the camera FOV as the reference display device. The reference display device is then to be utilized by the configuration application to determine display setting for any additional display devices relative to the reference display device.

During operation 405, the computer platform executing the configuration application may continue to request a graphic to be displayed on ones of the plurality of display devices until no additional client computing platforms acknowledge the request (for a networked platform system) or all display devices coupled to a common computing platform have been addressed (for a single platform system). The configuration application processes the collected camera image information as each target display device is caused to display the color or test pattern to map the target display device to a logical position within a logical view space based on the detected position within the known camera FOV. For example, the received camera image information may be processed by the computing platform executing the configuration application to map to a logical view space, which display device is left, right, above or below the reference display device.

If during operation 405, one or more displays are not detected by the camera for a particular acknowledging client, method 400 exits to back to operation 360 where the computing platform prompts the user to relocate the camera to include the additional display(s). The configuration method then returns to operation 410 and commences to cycle graphics through all displays to map any additional display devices in the camera FOV to the logical view space. As long as a previously mapped display device is included in the camera FOV (i.e., there is overlap between consecutive camera FOVs each time the camera is relocated), a coherent logical view space may be constructed. At operation 450, the display device physical position to logical view space mapping is stored as a configuration setting associated with each display device of the multiple display graphics rendering system.

Referring back to FIG. 2, in the exemplary embodiment depicted, view client display device 113 has an angular position rotated by ψ about the Y-Axis of the reference coordinate system of the view server display device 111 so that the vector N normal to the screen of the display devices 111 and 113 converge at the camera, C, for an angular position offset θ₃ (i.e. view angle offset). View client display device 112 also has a linear position, along the X-Axis of the reference coordinate system of the view server display device 111. Because the view client display device 112 is not also rotated about the Y-Axis, the vector N normal to the display screen does not coverage at the camera C. Nonetheless, there is a physical angular position offset θ₂. In further embodiments, display devices may also be rotated about one or more of the X-Axis and Z-Axis of the reference coordinate system. For example, a client display disposed above the view server display device 111 may be tilted down with an angular position rotated about the X-Axis of the reference coordinate system.

Performance of the screen position configuration method 400 may provide approximations of the angular position offsets, θ₂ and θ₃ for example, based on the known FOV of the camera. In a further embodiment however, display device orientation information is determined, which may for example provide an approximation of the display rotation angle ψ, from additional processing of image information received from the camera 110.

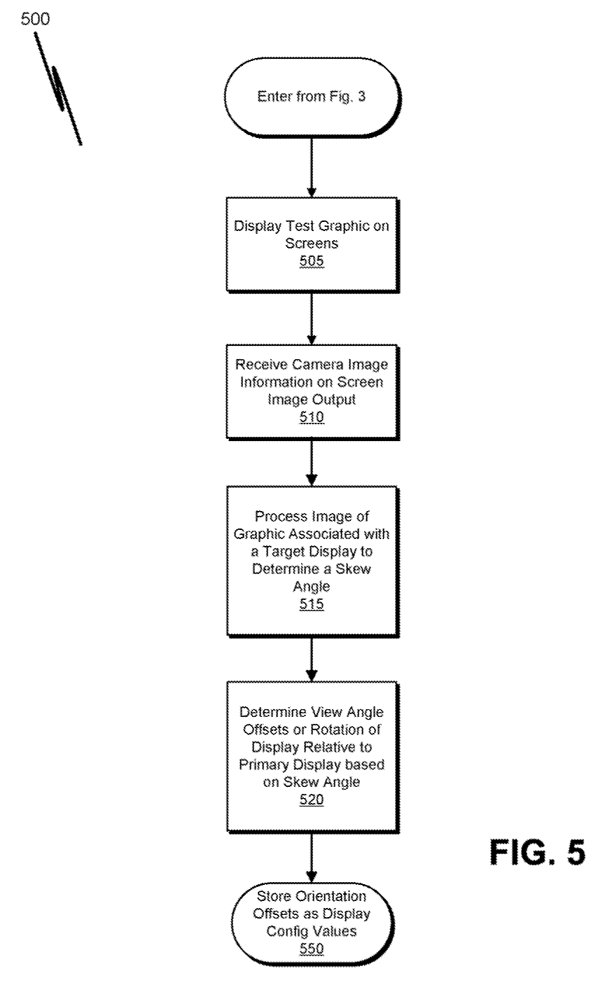

FIG. 5 illustrates flow diagram for a screen orientation configuration method 500, in accordance with one embodiment. Method 500 begins with a displaying a high contrast graphical test pattern on a screen of a target display device at operation 505. The display configuration application may cycle through the plurality of display devices previously mapped by the screen position configuration method 400, each time executing the screen orientation configuration method 500 such that a skew angle φ may be determined for each target display device. For example, as depicted in FIG. 2, (φ₁, φ₂, φ₃ may be determined for display devices 111, 112, 113, respectively. The high contrast test pattern may be any known in the art which provides for good edge detection. For example, a black crosshair or reticle over a white background may be displayed on the screen of the target display device, as shown in FIG. 2. In an alternative embodiment, a color providing high contrast with the target display device bezel, such as a bright white for a black bezel is displayed to detect and compare converging bezel edges (e.g., φ₃). In still other embodiments, test patterns are moved along known screen coordinates to determine such skew angles.

At operation 510, image information pertaining to the target display screen is received from the camera. During image data collection, display screens other than the target display screen may be blacked out with no display activity. At operation 515, the received image of the test pattern graphic display on the target display device is processed to determine the skew angle φ. In an embodiment, an edge detection algorithm is employed to process the received image data. Any edge detection algorithm known in the art may be employed. As depicted in FIG. 2, the target display device approximately in the center of the camera FOV will have a skew angle φ₁ closest to 90°. In other words, edges of the view server display device 111 and/or of the intersection of test pattern lines 211 and 221 will be nearly orthogonal for a conventional rectangular display screen while the skew angles φ₂ and φ₃ for view client display devices 112 and 113 will deviate relatively more from orthogonal. A display device orientation offset relative to the reference display device may then be estimated from the detectable deviation.

In other embodiments, edge detection algorithms may be employed to a detect edges of a series of graphical test patterns do determine which pattern in the series is viewed as most nearly horizontal or parallel to a analogous line graphic drawn on the reference display device. For example, the test pattern line 223 may be sequentially drawn across the screen of the view client display device 113 at a series of angles ω relative to the x-y coordinates of the view client display device 113. The test pattern line 221 may similarly be drawn by the view server display device 111. The computing platform may then receive the detected line images from the camera and determine the angle ω at which the test pattern line 223 was displayed corresponding to a detected edge as viewed from the camera vantage point closest to horizontal (or closest to parallel to the line 221). A skew angle for the target display may then be determined and with the camera's known lens distortion, a screen orientation offset relative to the reference display device may be estimated for the target display.

With an estimated skew angle for each display device of the system, at operation 520, trigonometric calculations known in the art may be performed by the computing platform executing the display configuration application to determine or refine estimates of physical linear position offsets and/or determine or refine physical angular position offsets (θ₂, θ₃) relative to the reference screen. Estimates of the display rotation angle ψ may also be used in conjunction with the physical angular position offset to distinguish between rotation of a display device and a physical size of display devices. At operation 550, a display orientation associated with the target display device is stored as a display configuration value.

In a further embodiment, rotation of a display device about the reference X-Axis may be determined through further analysis of a test pattern having a bias between an x and y dimension of the target display device. For example, as depicted in FIG. 2, the crosshair test pattern on view server display device 111 includes a first test pattern line 211 and a second test pattern line 221, the widths of which are discernable via image information provided by the camera 110. As such, a computer platform may assign a “portrait” orientation to the view server display device 111 based on optically detecting the wider first test pattern line 211 is vertically oriented. A “landscape” orientation may be similarly assigned to the view client display device 112 based on optically determining the wider first test pattern line 212 is horizontal and the narrower test pattern line 222 is vertical.

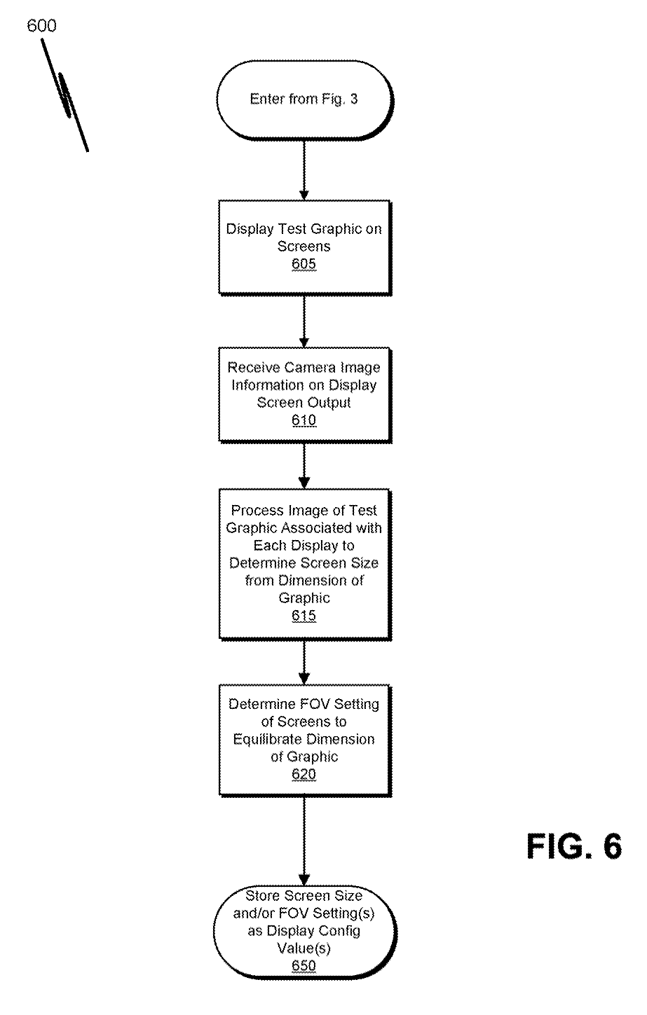

In an embodiment, an optically-based configuration routine determines a relative physical screen size for one or more display devices of a multiple display graphics rendering system. FIG. 6 illustrates flow diagram illustrating a screen size configuration method 600, in accordance with an exemplary embodiment. Method 600 begins with a displaying a high contrast graphical test pattern on a screen of a target display device at operation 605. The display configuration application may cycle through the plurality of display devices previously mapped by the screen position configuration method 400, executing the screen size configuration method 600 to determine a screen size for each display device of the system. The high contrast test pattern may be any known in the art which provides for good edge detection. For example, a black crosshair over a white background may be displayed on the target display device, as shown in FIG. 2.

At operation 610, image information pertaining to the target display screen is received from the camera, and at operation 615, the test pattern graphic associated with the target display device is processed to determine a screen size based on an optically determined dimension of the graphical test pattern. In an embodiment, an edge detection algorithm is applied to the image data received to find a first and second edge of a graphic displayed on the target display device. For example, as depicted in FIG. 2, the first test pattern 212 has first and second edges which may be determined based on a one dimensional intensity scan. From the edge detection algorithm, the dimension D₂ of a display graphic may be estimated to provide a relative screen size offset associated with the view client display device 112. A similar method may be employed to associate a dimension D₁ with a graphic displayed the view server display device 111. The relative screen sizes of display devices 111 and 112 and associated screen size offset between the two display devices may be utilized to maintain consistency in a graphics object apparent size across the two display devices.

In a further embodiment, at operation 620, the relative screen sizes may be scaled through modification of a FOV configuration setting associated with the particular display devices to equalize the dimensions D₁ and D₂. For example, as depicted in FIG. 2, the amount by which view client display device 112 is physically larger than view server display device 111 may be compensated by rendering a relatively larger FOV of a world scene on the view client display device 112 than is rendered for display on the view client display device 112. Increasing the FOV on view client display device 112 will have the effect of reducing the dimension D₂ of a displayed graphic, improving view coherency across the plurality of display devices. Concluding the method 600, the FOV scaling factor and/or the relative screen size dimensions are stored in as display configuration values at operation 650.

In another embodiment, adjacent ones of the plurality of display screens are controlled by a computing platform executing a display configuration routine to display a graphical test pattern. In one such embodiment, display screen spacing is determined pair-wise by displaying a test pattern on two display devices at a time and processing image data received by the a camera's view the display devices.

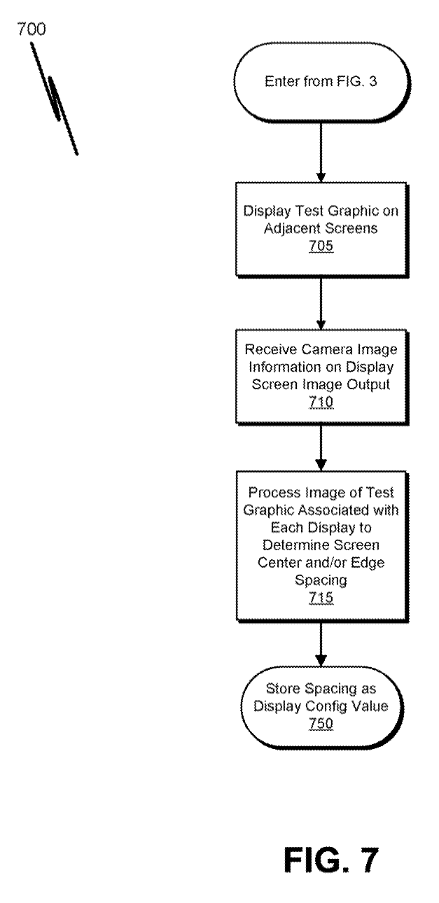

FIG. 7 illustrates flow diagram illustrating an exemplary screen spacing configuration method 700. Method 700 begins with a displaying a high contrast graphical test pattern on the display screens of two or more adjacent target display devices at operation 705. The display configuration application may cycle through the plurality of display devices previously mapped by the position configuration method 400 in a pair-wise manner, executing the screen spacing configuration method 700 to determine a screen spacing and/or alignment for each display device of the system. The high contrast test pattern may be any known in the art which provides for good edge detection. For example, a black crosshair over a white background may be displayed on the target display devices, as shown in FIG. 2.

At operation 710, image information pertaining to the adjacent target display screens is received from the camera, and at operation 715, the test pattern graphic associated with the target display devices is processed to determine a screen spacing, such as a screen center to center distance of adjacent devices or a screen edge to edge distance of adjacent display devices, based on edges detected during processing of the image information collected from the camera. Referring back to FIG. 2, in one embodiment, an edge detection algorithm is applied to the image data received to find a first vertical edge of each of the test pattern line 211 and the test pattern line 213 to determine H₃ as a relative screen center to center horizontal spacing or alignment offset along the reference X-Axis for the view client display device 113. H₃ may then be coupled with a skew angle determined from the screen orientation configuration method 500 to refine the position and orientation configuration values for the view client display device 113. In another embodiment, an edge detection algorithm is applied to the image data received to find a first horizontal edge of each of the test pattern lines 212 and 221 to determine V₁ as a relative screen center to center vertical spacing or alignment offset along the reference Y-Axis for the view client display device 112. At operation 750, V₁ is then stored as one of a set of display configuration values associated with view client display device 112. In a further embodiment, an edge detection algorithm is applied to the image data received to find a first edge of the adjacent bezels of display devices 111 and 112 to determine a relative screen edge to edge distance B₂ corresponding to dark space between the display devices.

Upon the completion of one or more of the configuration methods 400, 500, 600 and 700 for each of the plurality of display screens, display configuration method 300 is substantially completed with a set of display device layout dependent display offsets determined and stored. In this manner, an arbitrary physical layout of multiple displays of a graphics rendering system may be sufficiently determined to provide a coherent view responsive to a user's physical display device layout. With the layout offsets predetermined through the camera-based display configuration, viewing frustums may be subsequently rendered from a common world space position to form a mesh of view spaces of the same world scene across the display devices.

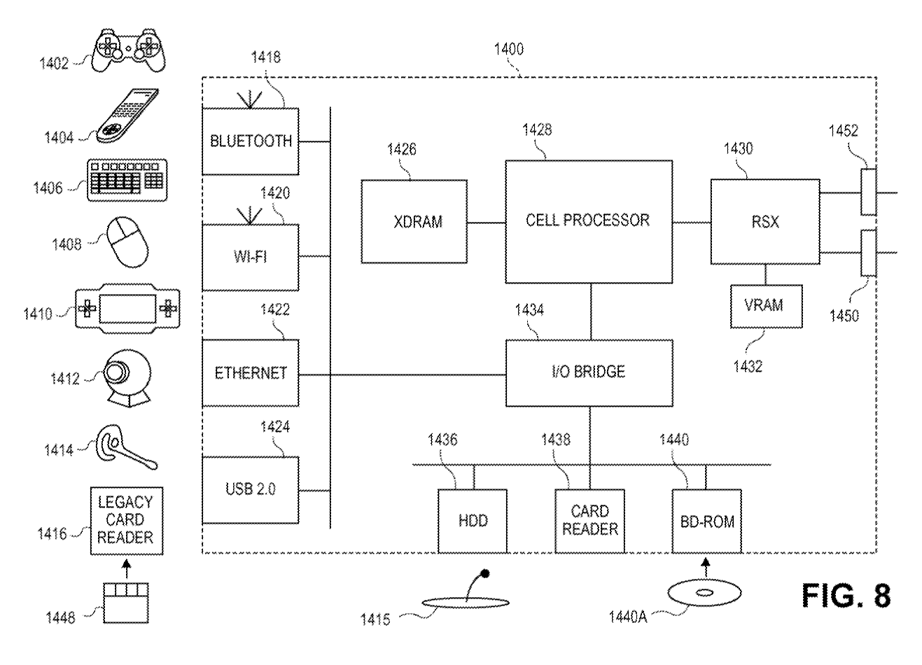

FIG. 8 illustrates hardware and user interfaces that may be used to determine display and audio speaker configuration settings, in accordance with one embodiment of the present invention. FIG. 8 schematically illustrates the overall system architecture of the Sony® Playstation 3® entertainment device, a console that may be compatible for implementing multiple display graphics rendering system. A platform unit 1400 is provided, with various peripheral devices connectable to the platform unit 1400. The platform unit 1400 comprises: a Cell processor 1428; a Rambus® dynamic random access memory (XDRAM) unit 1426; a Reality Simulator graphics unit 1430 with a dedicated video random access memory (VRAM) unit 1432; and an I/O bridge 1434. The platform unit 1400 also comprises a Blu Ray® Disk BD-ROM® optical disk reader 1440 for reading from a disk 1440A and a removable slot-in hard disk drive (HDD) 1436, accessible through the I/O bridge 1434. Optionally the platform unit 1400 also comprises a memory card reader 1438 for reading compact flash memory cards, Memory Stick® memory cards and the like, which is similarly accessible through the I/O bridge 1434.

The I/O bridge 1434 also connects to multiple Universal Serial Bus (USB) 2.0 ports 1424; a gigabit Ethernet port 1422; an IEEE 802.11b/g wireless network (Wi-Fi) port 1420; and a Bluetooth® wireless link port 1418 capable of supporting of up to seven Bluetooth connections.

In operation, the I/O bridge 1434 handles all wireless, USB and Ethernet data, including data from one or more game controller 1402. For example when a user is playing a game, the I/O bridge 1434 receives data from the game controller 1402 via a Bluetooth link and directs it to the Cell processor 1428, which updates the current state of the game accordingly.

The wireless, USB and Ethernet ports also provide connectivity for other peripheral devices in addition to game controller 1402, such as: a remote control 1404; a keyboard 1406; a mouse 1408; a portable entertainment device 1410 such as a Sony Playstation Portable® entertainment device; a video camera such as an EyeToy® video camera 1412; a microphone headset 1414; and a microphone 1415. Such peripheral devices may therefore in principle be connected to the platform unit 1400 wirelessly; for example the portable entertainment device 1410 may communicate via a Wi-Fi ad-hoc connection, while the microphone headset 1414 may communicate via a Bluetooth link.

The provision of these interfaces means that the Playstation 3 device is also potentially compatible with other peripheral devices such as digital video recorders (DVRs), set-top boxes, digital cameras, portable media players, Voice over IP telephones, mobile telephones, printers and scanners.

In addition, a legacy memory card reader 1416 may be connected to the system unit via a USB port 1424, enabling the reading of memory cards 1448 of the kind used by the Playstation® or Playstation 2® devices.

The game controller 1402 is operable to communicate wirelessly with the platform unit 1400 via the Bluetooth link, or to be connected to a USB port, thereby also providing power by which to charge the battery of the game controller 1402. Game controller 1402 can also include memory, a processor, a memory card reader, permanent memory such as flash memory, light emitters such as LEDs or infrared lights, microphone and speaker for ultrasound communications, an acoustic chamber, a digital camera, an internal clock, a recognizable shape such as a spherical section facing the game console, and wireless communications using protocols such as Bluetooth®, WiFi™, etc.

Game controller 1402 is a controller designed to be used with two hands. In addition to one or more analog joysticks and conventional control buttons, the game controller is susceptible to three-dimensional location determination. Consequently gestures and movements by the user of the game controller may be translated as inputs to a game in addition to or instead of conventional button or joystick commands. Optionally, other wirelessly enabled peripheral devices such as the Playstation™ Portable device may be used as a controller. In the case of the Playstation™ Portable device, additional game or control information (for example, control instructions or number of lives) may be provided on the screen of the device. Other alternative or supplementary control devices may also be used, such as a dance mat (not shown), a light gun (not shown), a steering wheel and pedals (not shown) or the like.

The remote control 1404 is also operable to communicate wirelessly with the platform unit 1400 via a Bluetooth link. The remote control 1404 comprises controls suitable for the operation of the Blu Ray™ Disk BD-ROM reader 1440 and for the navigation of disk content.

The Blu Ray™ Disk BD-ROM reader 1440 is operable to read CD-ROMs compatible with the Playstation and PlayStation 2 devices, in addition to conventional pre-recorded and recordable CDs, and so-called Super Audio CDs. The reader 1440 is also operable to read DVD-ROMs compatible with the Playstation 2 and PlayStation 3 devices, in addition to conventional pre-recorded and recordable DVDs. The reader 1440 is further operable to read BD-ROMs compatible with the Playstation 3 device, as well as conventional pre-recorded and recordable Blu-Ray Disks.

The platform unit 1400 is operable to supply audio and video, either generated or decoded by the Playstation 3 device via the Reality Synthesizer graphics unit 1430, through audio and video connectors to a display and sound output device such as a monitor or television set having a display and one or more loudspeakers. The audio connectors 1450 may include conventional analogue and digital outputs while the video connectors 1452 may variously include component video, S-video, composite video and one or more High Definition Multimedia Interface (HDMI) outputs. Consequently, video output may be in formats such as PAL or NTSC, or in 720p, 1080i or 1080p high definition.

Audio processing (generation, decoding and so on) is performed by the Cell processor 1428. The Playstation 3 device's operating system supports Dolby® 5.1 surround sound, Dolby® Theatre Surround (DTS), and the decoding of 7.1 surround sound from Blu-Ray® disks.

In the present embodiment, the video camera 1412 comprises a single charge coupled device (CCD), an LED indicator, and hardware-based real-time data compression and encoding apparatus so that compressed video data may be transmitted in an appropriate format such as an intra-image based MPEG (motion picture expert group) standard for decoding by the platform unit 1400. The camera LED indicator is arranged to illuminate in response to appropriate control data from the platform unit 1400, for example to signify adverse lighting conditions. Embodiments of the video camera 1412 may variously connect to the platform unit 1400 via a USB, Bluetooth or Wi-Fi communication port. Embodiments of the video camera may include one or more associated microphones and may also be capable of transmitting audio data. In embodiments of the video camera, the CCD may have a resolution suitable for high-definition video capture. In use, images captured by the video camera may for example be incorporated within a game or interpreted as game control inputs. In another embodiment the camera is an infrared camera suitable for detecting infrared light.

In general, for successful data communication to occur with a peripheral device such as a video camera or remote control via one of the communication ports of the platform unit 1400, an appropriate piece of software such as a device driver should be provided. Device driver technology is well-known and will not be described in detail here, except to say that those skilled in the art are aware that a device driver or similar software interface may be required in the present embodiment described.

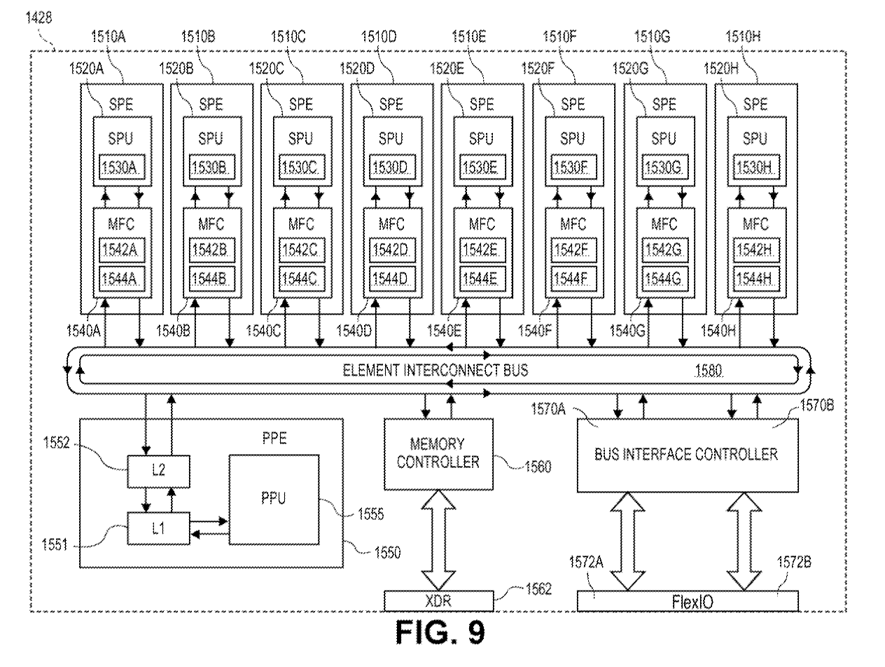

FIG. 9 illustrates additional hardware that may be used to process instructions, in accordance with one embodiment of the present invention. Cell processor 1428 of FIG. 8 as further illustrated in FIG. 7 has an architecture comprising four basic components: external input and output structures comprising a memory controller 1560 and a dual bus interface controller 1570A, B; a main processor referred to as the Power Processing Element 1550; eight co-processors referred to as Synergistic Processing Elements (SPEs) 1510A-H; and a circular data bus connecting the above components referred to as the Element Interconnect Bus 1580. The total floating point performance of the Cell processor is 218 GFLOPS, compared with the 6.2 GFLOPs of the Playstation 2 device's Emotion Engine.

The Power Processing Element (PPE) 1550 is based upon a two-way simultaneous multithreading Power 1470 compliant PowerPC core (PPU) 1555 running with an internal clock of 3.2 GHz. It comprises a 512 kB level 2 (L2) cache 1552 and a 32 kB level 1 (L1) cache 1551. The PPE 1550 is capable of eight single position operations per clock cycle, translating to 25.6 GFLOPs at 3.2 GHz. The primary role of the PPE 1550 is to act as a controller for the Synergistic Processing Elements 1510A-H, which handle most of the computational workload. In operation the PPE 1550 maintains a job queue, scheduling jobs for the Synergistic Processing Elements 1510A-H and monitoring their progress. Consequently each Synergistic Processing Element 1510A-H runs a kernel whose role is to fetch a job, execute it and synchronized with the PPE 1550.

Each Synergistic Processing Element (SPE) 1510A-H comprises a respective Synergistic Processing Unit (SPU) 1520A-H, and a respective Memory Flow Controller (MFC) 1540A-H comprising in turn a respective Dynamic Memory Access Controller (DMAC) 1542A-H, a respective Memory Management Unit (MMU) 1544A-H and a bus interface (not shown). Each SPU 1520A-H is a RISC processor clocked at 3.2 GHz and comprising 256 kB local RAM 1530A-H, expandable in principle to 4 GB. Each SPE gives a theoretical 25.6 GFLOPS of single precision performance. An SPU can operate on 4 single precision floating point members, 4 32-bit numbers, 8 16-bit integers, or 16 8-bit integers in a single clock cycle. In the same clock cycle it can also perform a memory operation. The SPU 1520A-H does not directly access the system memory XDRAM 1426; the 64-bit addresses formed by the SPU 1520A-H are passed to the MFC 1540A-H which instructs its DMA controller 1542A-H to access memory via the Element Interconnect Bus 1580 and the memory controller 1560.

The Element Interconnect Bus (EIB) 1580 is a logically circular communication bus internal to the Cell processor 1428 which connects the above processor elements, namely the PPE 1550, the memory controller 1560, the dual bus interface 1570A, B and the 8 SPEs 1510A-H, totaling 12 participants. Participants can simultaneously read and write to the bus at a rate of 8 bytes per clock cycle. As noted previously, each SPE 1510A-H comprises a DMAC 1542A-H for scheduling longer read or write sequences. The EIB comprises four channels, two each in clockwise and anti-clockwise directions. Consequently for twelve participants, the longest step-wise data-flow between any two participants is six steps in the appropriate direction. The theoretical peak instantaneous EIB bandwidth for 12 slots is therefore 96 B per clock, in the event of full utilization through arbitration between participants. This equates to a theoretical peak bandwidth of 307.2 GB/s (gigabytes per second) at a clock rate of 3.2 GHz.

The memory controller 1560 comprises an XDRAM interface 1562, developed by Rambus Incorporated. The memory controller interfaces with the Rambus XDRAM 1426 with a theoretical peak bandwidth of 25.6 GB/s.

The dual bus interface 1570A,B comprises a Rambus FlexIO® system interface 1572A, B. The interface is organized into 12 channels each being 8 bits wide, with five paths being inbound and seven outbound.

It is to be understood that the above description is intended to be illustrative, and not restrictive. For example, while the flow diagrams in the figures show a particular order of operations performed by certain embodiments of the invention, it should be understood that such order is not required (e.g., alternative embodiments may perform the operations in a different order, combine certain operations, overlap certain operations, etc.). Furthermore, many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. The scope of the invention should, therefore, be determined with reference to the appended claims, along with the full scope of equivalents to which such claims are entitled.

What is claimed is:

1. A computer graphics rendering system, comprising:
a first and second display device having a physical layout relative to each other;
a camera to provide image information indicative of the physical layout; and
a computer platform coupled to the camera, the computer platform to execute a configuration application to determine a display offset for the first display device relative to the second display device, wherein the display offset is dependent on the physical layout and determined based on the image information provided by the camera.

2. The system of claim 1, wherein the computing platform is communicatively coupled to each of the first and second display devices and is to control graphics displayed on one or more of the display devices while receiving the image information provided by the camera.

3. The system of claim 1, wherein the computing platform is to generate a logical position value for the first display device relative to a second display device.

4. The system of claim 3, wherein the computer platform is to execute an edge detection algorithm to map, to a logical view space, a detected position of the first display device within the camera FOV relative to a detected position of the second display device.

5. The system of claim 1, wherein the computing platform is to generate an alignment offset associated with the first display device, the alignment offset indicative of a distance between a centerline of the first display device and a centerline of the second display device.

6. The system of claim 1, wherein the computing platform is to determine a screen size offset for each of the plurality of display devices based on a dimensional comparison of a graphics object as recorded by the camera, the first display device displaying the graphics object with a first dimension and the second display device displaying the graphics object with a second dimension.

7. The system of claim 6, wherein the computing platform is to determine a field of view (FOV) setting based on the screen size offset.

8. The system of claim 7, wherein the FOV setting is to approximately equalize the first and second dimensions.

9. The system of claim 1, wherein the computing platform is to determine an orientation offset for the first display device relative to the second display device.

10. The system of claim 1, wherein the computing platform is to further determine an audio configuration setting of at least one audio channel of the computer graphics rendering system to based on audio input received from a microphone of the camera.

11. A method of configuring a plurality of display devices to provide a coherent view across the plurality, the method comprising:
receiving image information from a camera having the plurality of display devices within the camera field of view (FOV);
processing the received image information to determine a parameter indicative of a physical layout of the plurality of the display devices; and
determining a display offset for a first display device based on the physical layout parameter.

12. The method of claim 11, further comprising:
setting the reference display device to be the display device approximately in the center of the camera FOV;
cycling a video test pattern through each of the plurality of displays;
detecting the cycled video test pattern with the camera; and
mapping to a logical view space a detected position of the first display device within the camera FOV relative to the reference display.

13. The method of claim 11, wherein the display offset is an alignment offset between a centerline of the first display device and a centerline of the reference display device.

14. The method of claim 11, wherein the display offset is a screen size offset between the first display device and the reference display device.

15. The method of claim 14, wherein determining the screen size offset further comprises:
displaying a graphic with a first display device;
determining a first dimension of the graphic based on the received image information;
displaying the graphic with a second display device;
determining a second dimension of the graphic based on the received image information; and
comparing the first dimension with the second dimension.

16. The method of claim 14, further comprising determining a field of view (FOV) setting based on the size offset for the first display device to provide a consistent size of a same graphic displayed on each of the first display device and the reference display device.

17. The method of claim 11, wherein the display offset is an orientation offset of the first display device relative to the reference display device.

18. The method of claim 17, wherein determining the orientation offset further comprises:
processing the received image information with an edge detection algorithm to determine a view angle offset between the first display device and the reference display device.

19. The method of claim 18, wherein determining the orientation offset further comprises:
displaying a graphic on a first display device; and
processing the received image information with an edge detection algorithm to determine if the first display device is in a portrait or landscape mode.

20. A computer-readable medium having stored thereon a set of instructions which when executed cause a processing system to perform the method of claim 11.
